(19) United States
(12) Patent Application Publication
(10) Pub. No.: US 2004/0119438 A1
(43) Pub. Date: Jun. 24, 2004

(54) Battery-supplied alternator

(76) Inventors: Bernd Heigl, Augsburg (DE); Joerg Riethmueller, Landsberg (DE); Bernd Ziegler, Hiltenfingen (DE)

Correspondence Address: DAVID TOREN, ESQ., SIDLEY, AUSTIN, BROWN & WOOD, LLP, 787 SEVENTH AVENUE, NEW YORK, NY, 10019-6018, US

(21) Appl. No.: 10/674,559

(22) Filed: Sep. 30, 2003

(30) Foreign Application Priority Data
Oct. 1, 2002 (DE) 102 45 839.1

(51) Int. Cl. H02P 1/24

(52) U.S. Cl. 318/727

(57) ABSTRACT

A battery-supplied inverter (1) for a brushless electric motor (2) having a plurality of phase windings (3a, 3b, 3c), which is connected in a supply current delta connection (4a) via two supply current lines (5) with a supplying battery (6) having a plurality of battery cells (8), wherein it is connected with the battery (6) in at least one second supply current delta connection (4b, 4c) via supply current lines (5).

### BACKGROUND OF THE INVENTION

The invention relates to an inverter for a brushless electric motor having a plurality of phase windings, which is supplied by a battery having a plurality of battery cells.

Brushless electric motors are used for efficient drives, in hand tool machines, whose phase windings are supplied with current from an inverter. The inverter itself, which usually comprises power semiconductors, is supplied with d.c. current, which in mains supplied applications is generated in a d.c. intermediate circuit and in non-mains applications is supplied by a battery.

In conventional batteries with a plurality of battery cells in series, the increase of battery capacity obtained by connecting battery cells in series results in high battery voltage, which can only be switched using special power semiconductors having sufficiently high maximum reverse voltage and, upon exceeding the protective low voltage, requires additional protection measures at the battery and an associated charging unit.

According to DE19526996, a battery-supplied inverter for a brushless electric motor having a plurality of phase windings has a battery with a plurality of battery cells arranged in series for supplying the inverter via one supply delta connection. The several battery cells are connected to a monitoring logic via intermediate measurement points, which controls the supply current. The supply current taken from the battery is limited upward to avoid a damaging deep discharge of the weakest battery cell, of all the battery cells arranged in series of the supply current delta connection. The residual capacity of the other battery cells cannot be utilized for the electric motor, whereby the usable power is temporarily limited.

### SUMMARY OF THE INVENTION

The object of the invention is to provided a battery-powered inverter for a brushless electric motor having improved utilization of a battery having a plurality of battery cells. A further aspect of the invention relates to providing an associated battery as a charging unit therefor.

The object is achieved by a battery-powered inverter for an electric motor having a plurality of phase windings has a supplying battery having a plurality of battery cells for supplying the inverter in a supply current delta connection over two supply current lines, wherein at least one second supply current delta connection is connected via a third supply current line to the inverter.

At least two different supply current delta connections are formed by the third supply current line connected to the inverter that make different cell currents of the battery cells possible. A weak battery cell thus does not limit the supply current of another battery cell, which is arranged in another supply current delta connection.

Advantageously, each supply current delta connection is associated with one inverter section for each phase winding of the brushless electric motor, whereby the battery cells have a uniform load.

Advantageously, the inverter is realized using power semiconductors like Power-MOSFETs or IGBTs, whereby higher currents can be selected with low losses.

Advantageously, the inverter is configured for controlled switching of at least three phase windings of a brushless electric motor, whereby a rotating field can be generated.

Advantageously, the inverter is configured for controlled switching of precisely three phase windings of a brushless electric motor, which represent an appropriate compromise relative to small electric motors for hand tool machines.

Advantageously, the inverter has a sensor for each of the power supply delta connections; also advantageously, a current sensor and/or voltage sensor and/or temperature sensor, whereby the status of the battery cell in the supply current delta connection can be monitored by a control element such as a microcontroller.

Advantageously, the control element is connected with the inverter, whereby the inverter can be controlled depending on the status of the battery cells, particularly such that undesirable high currents and/or depth discharges relative to the individual cell groups of battery cells can be avoided.

### SUMMARY OF THE INVENTION

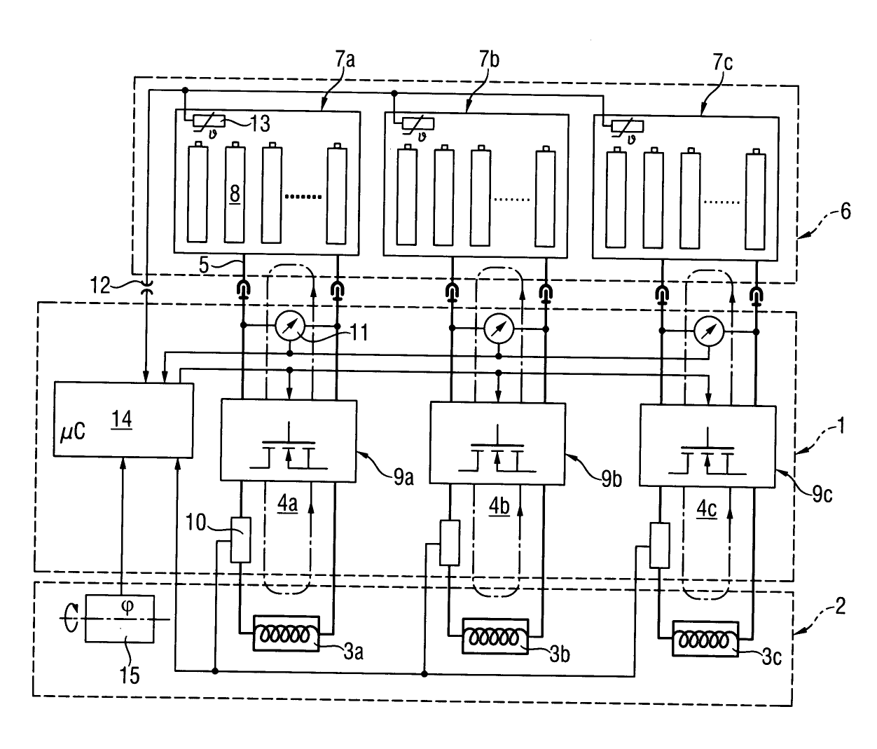

The exemplary embodiment of the invention will be described with reference to the drawings, wherein FIG. 1 shows a battery-supplied inverter for a brushless electric motor, in accordance with the invention.

### DETAILED DESCRIPTION OF THE INVENTION

FIG. 1 shows a battery-supplied inverter 1 for a brushless electric motor 2 having three phase windings 3a, 3b, 3c with a battery having three cell groups 7a, 7b, 7c of battery cells 8 supplying the inverter 1 in three supply current delta connections 4a, 4b, 4c via six supply lines 5 having load contacts. Each supply current delta connection 4a, 4b, 4c is associated with an inverter section 9a, 9b, 9c having power semiconductors for each phase winding 3a, 3b, 3c of the brushless electric motor 2. The inverter 1 has one sensor for each supply current delta connection 4a, 4b, 4c in the form of current sensors 10, voltage sensors 11 and temperature sensors 13 connected via measurement points 12 with the cell groups 7a, 7b, 7c in the battery, which are connected with the control element 14 in the form of a microcontroller controlled by a rotating sensor 15 in the electric motor 2, which is connected to the inverter 1.

What is claimed is:

1. A battery-supplied inverter for a brushless electric motor (2) having a plurality of phase windings (3a, 3b, 3c) being connected in a supply current delta connection via two supply current lines (5) to a supplying battery (6) with a plurality of battery cells (8), wherein at least one second supply current delta connection (4b, 4c) is connected to the battery (6) via supply current lines (5).

2. The inverter according to claim 1, wherein each supply current delta connection (4a, 4b, 4c) is associated with an inverter section (9a, 9b, 9c) for each phase winding (3a, 3b, 3c) of the brushless motor (2).

3. The inverter of claim 2, the inverter section (9a, 9b, 9c) has power semiconductors for each phase winding (3a, 3b, 3c) of the brushless motor (2).

4. The inverter of claim 3, wherein the inverter is electrically configured for controlled switching of at least three phase windings (3a, 3b, 3c) of the brushless electric motor (2).

5. The inverter of claim 4, further comprising one sensor for each supply current delta connection (4a, 4b, 4c) and wherein the sensor is connected with a control element (14).

6. The inverter of claim 5, wherein the sensor is at least one of a voltage sensor (10) and a current sensor (11) and a temperature sensor (13).

7. The inverter of claim 6, wherein the control element (14) is connected with the inverter (1).

8. The inverter of claim 6, wherein the temperature sensor (13) is arranged in the battery (6) and is connected to the control element (14) via measurement points (12).
